(19) United States
(12) Patent Application Publication
(10) Pub. No.: US 2010/0257176 A1
(43) Pub. Date: Oct. 7, 2010

(54) METHOD FOR GENERATING HASH KEYS AND APPARATUS FOR USING THE SAME

(75) Inventor: KUO CHENG LU, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/550,759

(22) Filed: Aug. 31, 2009

(30) Foreign Application Priority Data
Apr. 3, 2009 (TW) 098111113

(51) Int. Cl. G06F 17/30

(52) U.S. Cl. 707/741; 707/E17.044

(57) ABSTRACT

The method for generating hash keys comprises cascading an input data set with a prefix data set, rotating the input data set with an offset data set and performs at least one XOR operation to generate a temporary key. Subsequently, the temporary key is cascaded with a supplementary data set to generate a hash key. In addition, by appropriately adjusting the length of the offset data set, the probability of collision of hash keys can be reduced.

### BACKGROUND OF THE INVENTION

1. Field of the Invention

The present invention relates to a method and apparatus for generating hash keys.

2. Description of the Related Art

Hashing methods are widely used for network bridges or routers to look up IP addresses. Conventional search methods such as sequential search methods or binary search methods utilize key values for comparison operations. The search efficiencies of conventional search methods affected by the number of repetitions needed to complete comparison operations. Unlike conventional methods, hashing methods directly translate input data sets to corresponding locations. Thus, locations of records of the input data sets can be obtained by directly translating input data sets without any comparison operations. The search efficiencies of the hashing methods are not affected by data quantities and by the number of repetitions needed for comparison operations. However, collision may occur due to different input data sets, i.e., different input data sets may be translated to the same location. If there is enough memory space, or if a method for generating hash keys is designed appropriately, the probability of collision can be reduced. In addition, the time spent for translating input data sets and the acceptable lengths for input data sets are important criteria for the methods used for generating hash keys. Due to limitations of memory space for recording data sets, a method for generating hash keys that can quickly translate, accept input data sets with different lengths and reduce probability of collision is demanded by the market.

### SUMMARY OF THE INVENTION

The method and apparatus for generating hash keys in accordance with the invention cascade an input data set with a prefix data set, rotate the input data set with an offset data set, and perform at least one XOR operation to generate a temporary key. Subsequently, the temporary key is cascaded with a supplementary data set to generate a hash key. In addition, by appropriately adjusting the length of the offset data set, the probability of the collision of hash keys can be reduced.

One embodiment of the present invention discloses a method for generating hash keys comprising the steps of: receiving an input data set; setting a varying range of the input data set to N bits, a unit length to U bits and the quantity of hash tables to W, where N, U and W are positive integers; performing at least one XOR operation to generate a first temporary hash key in accordance with the length of the input data set and the unit length; performing an XOR operation to generate a second temporary hash key in accordance with the unit length and the first temporary hash key; cascading the second temporary hash key with the last L-bit data set of the first temporary hash key to generate a hash key, where L is a positive integer.

Another embodiment of the invention discloses an apparatus for generating hash keys comprising a receiving unit, a setting unit, a checking unit, an operating unit, a cascading unit, a storing unit and a rotating unit. The receiving unit is utilized for receiving an input data set. The setting unit is utilized for setting a varying range of the input data set to N bits, a unit length to U bits and the quantity of hash tables to W, where N, U and W are positive integers. The checking unit is utilized for checking the length of the input data set in accordance with the unit length. The operating unit is utilized for performing at least one XOR operation to generate a first temporary hash key and a second temporary hash key in accordance with the length of the input data set and the unit length. The cascading unit is utilized for cascading the input data set with a prefix data set or cascading the second temporary hash key with a supplementary data set to generate a hash key with the length of (N−log₂W) bits. The storing unit is utilized for storing the input data set, the first temporary hash key and the second temporary hash key. The rotating unit is utilized for rotating the input data set in accordance with the offset length.

### BRIEF DESCRIPTION OF THE DRAWINGS

The invention will be described according to the appended drawings in which:

FIG. 1 shows a flowchart illustrating the preferred embodiment of the method for generating hash keys;

FIG. 2 is a diagram for an input data set with the length of 48 bits in accordance with one embodiment of the present invention;

FIG. 3 is a diagram for another input data set in accordance with another embodiment of the present invention; and

FIG. 4 is a block diagram of the apparatus for generating hash keys in accordance with another embodiment of the present invention.

### PREFERRED EMBODIMENT OF THE PRESENT INVENTION

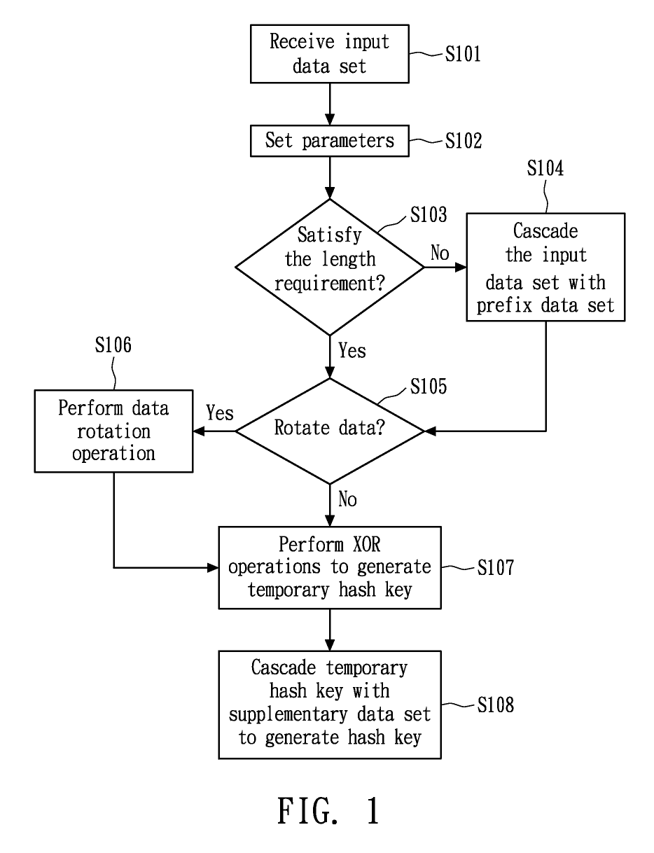

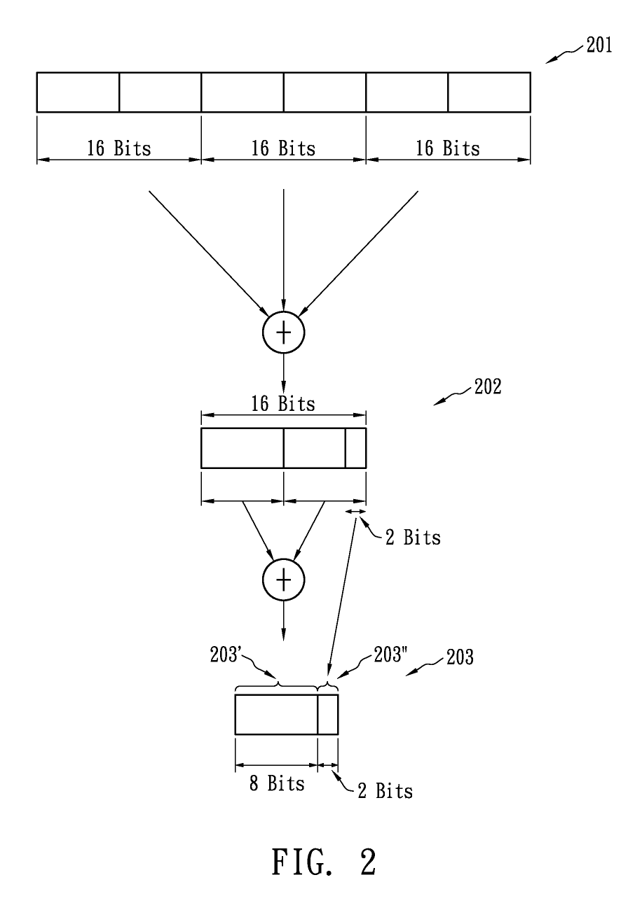

FIG. 1 shows a flowchart illustrating the preferred embodiment of the method for generating hash keys. The following utilizes FIG. 1 and FIG. 2 together to illustrate the process of the method for generating hash keys. In step S101, an input data set 201 with the length of 48 bits is received. In step S102, related parameters are set in accordance with the requirements of a user. In this embodiment, the varying range of the input data set 201 is 11 bits, the unit length is 8 bits and the quantity of hash tables is 2. In step S103, the length of the input data set 201 is checked to determine whether the length of the input data set 201 is an even multiple of the unit length. If it is not, the input data set 201 is cascaded with a prefix data set so that the length of the input data set 201 cascaded with the prefix data set is an even multiple of the unit length. In this embodiment, the length of the input data set 201 is an even multiple of the unit length. In step S105, the input data set 201 is checked to determine whether it is rotated. If it is, the input data set 201 is rotated in step S106. In step S105, the determination of whether the input data set 201 is rotated can be performed in accordance with the parameters set in step S102. In this embodiment, a data set rotation operation is not set in step S102. In step S107, XOR operations are performed to generate a temporary hash key. In this embodiment, a 16-bit length (2 times the unit length) is utilized as a unit for performing XOR operations to generate a first temporary hash key 202, wherein the length of the first temporary hash key 202 is 16 bits. Next, an 8-bit length (the unit length) is utilized as a unit for performing XOR operations to generate a second temporary hash key 203′, wherein the second length of the second temporary hash key 203′ is 8 bits. In step S108, the second temporary hash key 203′ is cascaded with a supplementary data set 203″ to generate a hash key 203. The length of the hash key 203 is 10 bits. The supplementary data set 203″ is the last 2-bit data set of the first temporary hash key 202. The length of the supplementary data set 203″ is determined in accordance with the varying range of the input data set 202, the unit length and the quantity of hash tables. If the varying range of an input data set is N bits, the unit length is U bits and the quantity of hash tables is W, where N, W and U are positive integers, then the length of a supplementary data set is (N−log₂W−U) bits. In this embodiment, N, W and U are 11, 2 and 8, respectively. Therefore, the length of the supplementary data set 203″ is (11−log₂2−8) bits, i.e. 2 bits. Input data sets with the length of 48 bits can be placed in two hash tables with hash keys generated by this embodiment, wherein the capacity of each hash table is 10 bits.

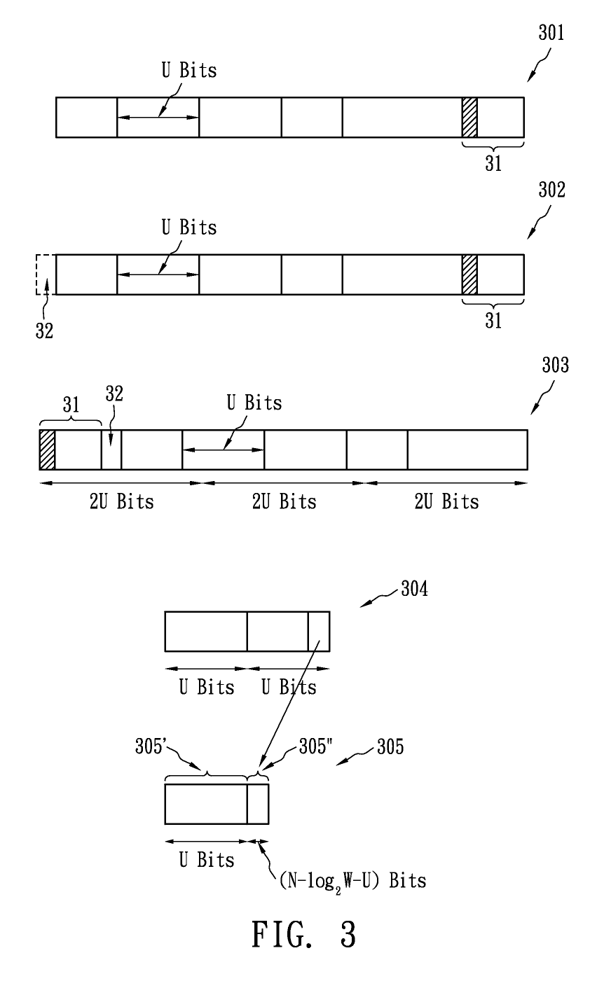

The following utilizes FIG. 1 and FIG. 3 together to illustrate the process of the method for generating hash keys in accordance with another embodiment to enable those skilled in the art to practice the present invention.

In step S101, an input data set 301 is received. In step S102, related parameters are set in accordance with the requirements of a user. In this embodiment, an offset data set 31 to be rotated is set, a varying range of the input data set 301 is N bits, a unit length is U bits and the quantity of hash tables is W, where N, U and W are positive integers. In step S103, the length of the input data set 301 is checked to determine whether the length of the input data set 201 is an even multiple of the unit length. If it is not, the length of the input data set 301 is cascaded with a prefix data set 32 so that the length of the cascaded data set 302 is an even multiple of the unit length. In step S105, the input data set 301 is checked to determine whether it is rotated. If it is, a data rotation operation is performed in step S106. In this embodiment, after rotating the offset data set 31 in step S106, a rotated data set 303 is obtained. In step S107, XOR operations are performed to generate a temporary hash key. In this embodiment, a 2U-bit length is utilized as a unit for performing XOR operations to generate a first temporary hash key 304, wherein the length of the first temporary hash key 304 is 2U bits. Next, a U-bit length is utilized as a unit for performing XOR operations to generate a second temporary hash key 305′, wherein the length of the second temporary hash key 305′ is U bits. In step S108, the second temporary hash key 305′ is cascaded with a supplementary data set 305″ to generate a hash key 305. The length of the supplementary data set is (N−log₂W−U) bits. The supplementary data set 305″ is the last (N−log₂W−U)-bit data set of the first temporary hash key 304. Input data sets with the length of N bits can be arranged in W hash tables with the hash key generated by this embodiment, wherein the capacity of each hash table is (N−log₂W) bits.

In addition to the above-mentioned hash key generating method, an apparatus for generating hash keys in accordance with another embodiment is described as follows to enable those skilled in the art to practice the present invention.

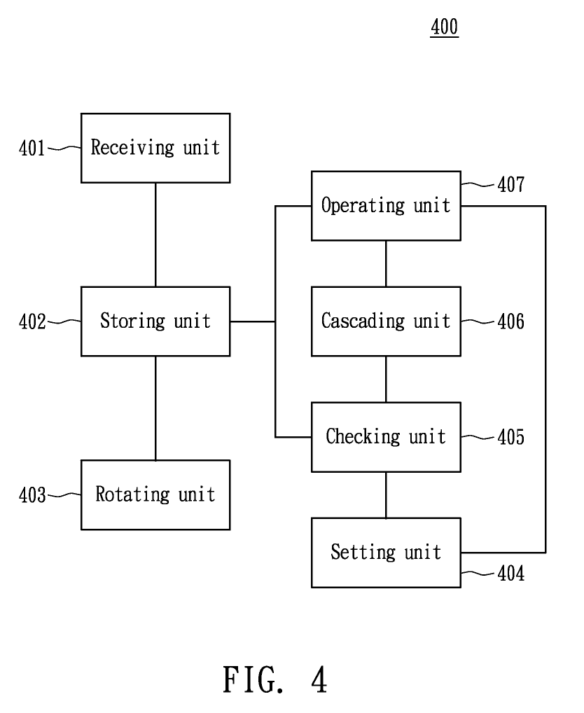

FIG. 4 is a block diagram of the apparatus for generating hash keys in accordance with another embodiment of the present invention. The hash key generating apparatus 400 comprises a receiving unit 401, a storing unit 402, a rotating unit 403, a setting unit 404, a checking unit 405, a cascading unit 406 and an operating unit 407. The receiving unit 401 is utilized for receiving an input data set. The setting unit 404 is utilized for setting a varying range of the input data set to N bits, a unit length to U bits and the quantity of hash tables to W, where N, U and W are positive integers, and the setting unit 404 is also utilized for setting an offset length. The checking unit 405 is utilized for checking the length of the input data set in accordance with the unit length. The operating unit 407 is utilized for performing at least one XOR operation to generate a first temporary hash key and a second temporary hash key in accordance with the unit length and the length of the input data set, wherein a 2U-bit length or a U-bit length is set as a unit for the operating unit 407 to perform XOR operations. In this embodiment, the lengths of the first temporary hash key and the second temporary hash key are 2U bits and U bits, respectively. The cascading unit 406 is utilized for cascading the input data set with a prefix data set or cascading the second temporary hash key with a supplementary data set to generate a hash key with the length of (N−log₂W) bits, wherein the supplementary data set with the length of (N−log₂W−U) bits is the partial data of the first temporary hash key. The storing unit 402 is utilized for storing the input data set, the first temporary hash key and the second temporary hash key. The rotating unit 403 is utilized for rotating the input data set in accordance with the offset length.

The above-described embodiments of the present invention are intended to be illustrative only. Numerous alternative embodiments may be devised by persons skilled in the art without departing from the scope of the following claims.

What is claimed is:

1. A method for generating hash keys comprising the steps of:
receiving an input data set;
setting a varying range of the input data set to N bits, a unit length to U bits and a quantity of hash tables to W, where N, U and W are positive integers;
performing at least one exclusive-or (XOR) operation to generate a first temporary hash key in accordance with the length of the input data set and the unit length;
performing an XOR operation to generate a second temporary hash key in accordance with the unit length and the first temporary hash key; and
cascading the second temporary hash key with the last L bits of the first temporary hash key to generate a hash key, where L is a positive integer.

2. The method of claim 1, further comprising a step of:
cascading the input data set with a prefix data set so that the cascaded length is an even multiple of the unit length if the length of the input data set is not an even multiple of the unit length.

3. The method of claim 1, further comprising a step of setting an offset length.

4. The method of claim 3, further comprising a step of rotating the input data set in accordance with the offset length.

5. The method of claim 1, wherein the length of the first temporary hash key is 2U bits.

6. The method of claim 1, wherein the length of the second temporary hash key is U bits.

7. The method of claim 1, wherein a 2U-bit length is set as a unit for performing the at least one XOR operation to generate the first temporary hash key.

8. The method of claim 1, wherein a U-bit length is set as a unit for performing the XOR operation to generate the second temporary hash key.

9. The method of claim 1, wherein the length of the hash key is (N−log₂W) bits.

10. The method of claim 1, wherein the value of L is obtained by an equation, L=N−log₂W−U.

11. An apparatus for generating hash keys, comprising:
a receiving unit for receiving an input data set;
a setting unit for setting a varying range of the input data set to N bits, a unit length to U bits and a quantity of hash tables to W, where N, U and W are positive integers;
a checking unit for checking the length of the input data set in accordance with the unit length;
an operating unit for performing at least one XOR operation to generate a first temporary hash key and a second temporary hash key in accordance with the length of the input data set and the unit length; and
a cascading unit for cascading the input data set with a prefix data set or cascading the second temporary hash key with a supplementary data set to generate a hash key.

12. The apparatus of claim 11, further comprising a storing unit for storing the input data set, the first temporary hash key and the second temporary hash key.

13. The apparatus of claim 11, further comprising a rotating unit for rotating the input data set in accordance with the offset length.

14. The apparatus of claim 11, wherein the supplementary data set is a partial data set of the first temporary hash key

15. The apparatus of claim 11, wherein a 2U-bit length is set as a unit for the operating unit to perform the XOR operation.

16. The apparatus of claim 11, wherein a U-bit length is set as a unit for the operating unit to perform the XOR operation.

17. The apparatus of claim 11, wherein the length of the first temporary hash key is 2U bits.

18. The apparatus of claim 11, wherein the length of the second temporary hash key is U bits.

19. The apparatus of claim 11, wherein the length of the supplementary data set is (N−log₂W−U) bits.

20. The apparatus of claim 11, wherein the length of the hash key is (N−log₂W) bits.
